(19) United States
(12) Patent Application Publication
(10) Pub. No.: US 2009/0043859 A1
(43) Pub. Date: Feb. 12, 2009

(54) BROADCAST RECEIVING APPARATUS

(76) Inventor: Tatsuya Wada, Osaka (JP)

Correspondence Address: MORGAN LEWIS & BOCKIUS LLP, 1111 PENNSYLVANIA AVENUE NW, WASHINGTON, DC, 20004, US

(21) Appl. No.: 12/185,401

(22) Filed: Aug. 4, 2008

(30) Foreign Application Priority Data
Aug. 9, 2007 (JP) 2007-208275

(51) Int. Cl. G06F 15/16

(52) U.S. Cl. 709/206

(57) ABSTRACT

An MPU of a digital broadcast receiver comprises: a still image generating portion that receives input operation by the user through a remote controller and, based on the received input operation, generates still image information corresponding to video image information received through a receiving portion; and an image transmitting portion that receives input operation by the user through the remote controller, and that, based on the received input operation, attaches the still image information generated by the still image generating portion to an electronic mail message as an attached file and transmits through the Internet the electronic mail message to which the still image information is attached to an electronic mail address stored in an address memorizing portion.

This application is based on Japanese Patent Application No. 2007-208275 filed on Aug. 9, 2007, the contents of which are hereby incorporated by reference.

### BACKGROUND OF THE INVENTION

1. Field of the Invention

The present invention relates to a broadcast receiving apparatus that is arranged to be capable of transmitting electronic mail through a network, that receives television broadcast, and that is connected to a monitor to display thereon received video image information. More particularly, the present invention relates to a broadcast receiving apparatus connected in a communicable manner to a remote controller provided with a plurality of keys, arranged to be capable of transmitting electronic mail through a network, receiving television broadcast, and connected to a monitor to display thereon received video image information.

2. Description of Related Art

For a broadcast receiving apparatus that receives television broadcast and is connected to a monitor to display thereon received video image information, various types of devices and methods for generating still image information corresponding to the received video image information have been proposed to enhance the user friendliness.

For example, JP-A-2007-180726 discloses a digital broadcast receiving apparatus provided with a still image capture portion for obtaining video image data from a display portion according to a control command from a controller, converting the data into an image file in such a format as JPEG, and storing the result into a memory as a still video image.

However, in the conventional broadcast receiving apparatus such as the digital broadcast receiving apparatus described above, although it is possible to display the still image on the monitor, it is difficult to sufficiently utilize the generated still image information. More specifically, it is difficult to conveniently utilize the generated still image information in such a wide range of application as a screen wallpaper in a personal computer or displaying the generated still image information on a monitor of a personal computer or the like for the purpose of writing down on a postcard the character information included in the still image such as a mailing address for taking part in a prize competition or the like.

### SUMMARY OF THE INVENTION

The present invention is made in view of the foregoing problems, and it is an object of the present invention to provide a broadcast receiving apparatus capable of conveniently utilizing still image information corresponding to video image information.

To achieve the object, a broadcast receiving apparatus of the present invention arranged to be capable of transmitting electronic mail via a network, receiving television broadcast, and connected to a monitor in such a manner as to display received video image information on the monitor, comprises: address memorizing portion for storing electronic mail address information in advance; receiving portion for receiving television broadcast of a preset channel; still image generating portion that receives input operation performed externally, and that, based on the input operation thus received, generates still image information corresponding to video image information received through the receiving portion; and image transmitting portion that receives input operation performed externally, and that, based on the input operation thus received, attaches the still image information generated by the still image generating portion to an electronic mail message as an attached file and transmits the electronic mail message to which the still image information is attached to an electronic mail address indicated by the electronic mail address information stored in the address memorizing portion.

According to this arrangement, the electronic mail address information is stored in the address memorizing portion in advance, and television broadcast of a channel that is preset by the receiving portion is received. Then, input operation performed externally is received, and, on the basis of the received input operation, still image information corresponding to video image information received through the receiving portion is generated. Additionally, input operation performed externally is received, then the generated still image information is attached to an electronic mail message as an attached file on the basis of the received input operation, and the electronic mail message to which the still image information is attached is transmitted through a network to an electronic mail address indicated by the electronic mail address information stored in the address memorizing portion. Accordingly, it is possible to conveniently utilize the still image information that corresponds to the video image information.

### BRIEF DESCRIPTION OF THE DRAWINGS

FIG. 1 is a block diagram showing one example of a configuration of a digital broadcast receiver according to the present invention;

FIG. 2 is a front view showing one example of a remote controller;

FIG. 3 is a block diagram showing one example of a configuration of the principal portion of a digital broadcast receiver 1 according to the present invention;

FIG. 4A is a screen view showing one example of an address input screen displayed on a display by an address setting portion;

FIG. 4B is a diagram of a screen showing one example of a transmission instruction screen displayed on a display by the image transmission portion; and

FIG. 5 is a flowchart showing one example of the operation of a digital broadcast receiver (particularly, MPU).

### DETAILED DESCRIPTION OF PREFERRED EMBODIMENTS

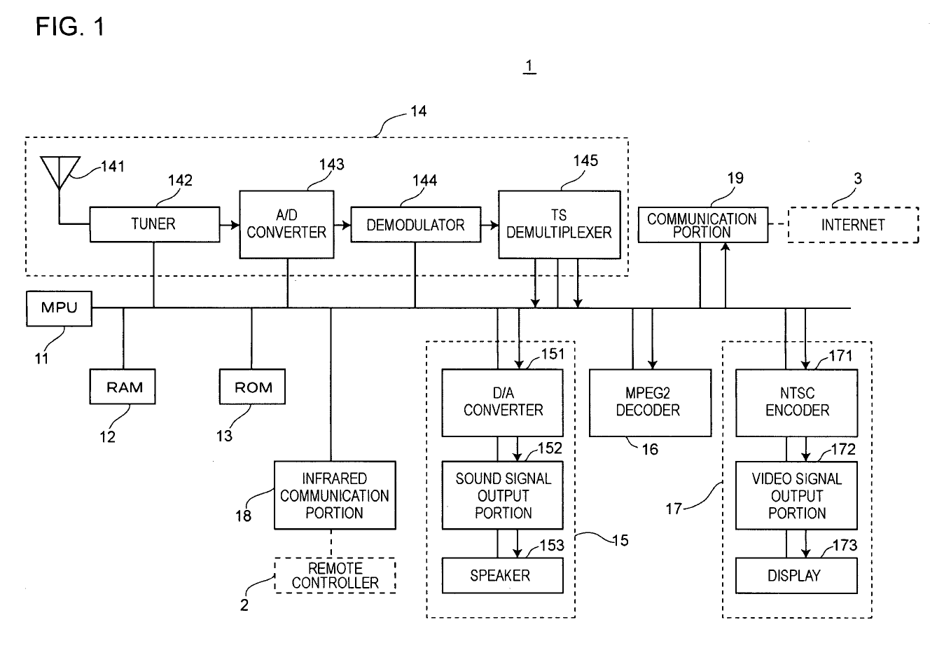

Hereinafter, embodiments of the present invention will be described with reference to the accompanying drawings. FIG. 1 is a block diagram showing one example of a configuration of a digital broadcast receiver 1 according to the present invention. The digital broadcast receiver 1 (broadcast receiver) is connected to a remote controller 2 in a communicable manner by means of infrared communication. In addition, the digital broadcast receiver 1 is so arranged to be capable of transmitting electronic mail to a personal computer (not shown) or the like that is connected to the digital broadcast receiver 1 via the Internet 3 (network).

The digital broadcast receiver 1, by receiving input operation by the user, receives television broadcast and outputs the video image and sound to a display 173 and a speaker 153, respectively, and comprises an MPU 11, a RAM 12, a ROM 13, a receiving portion 14, a sound output portion 15, an MPEG2 decoder 16, an image output portion 17, an infrared communication portion 18, and a communication portion 19.

The MPU (Micro Processing Unit) 11 controls an entire function of the digital broadcast receiver 1. The RAM (Random Access Memory) 12 stores such information as the sound information and the video image information in a read and write manner. The ROM (Read Only Memory) 13 stores a control program or the like for operating the MPU 11.

The receiving portion 14 receives and demodulates television broadcast, and comprises an antenna portion 141, a tuner 142, an A/D converter 143, a demodulator 144, and a TS demultiplexer 145.

The antenna portion 141 receives television broadcast waves. The tuner 142 selects a broadcast program from among preset channels in the television broadcast waves received by the antenna portion 141. The A/D converter 143 converts the output signal (analog signal) from the tuner 142 into digital information. The demodulator 144 demodulates the outputted information from the A/D converter 143. The TS (Transport Stream) demultiplexer 145 separates the outputted information demodulated by the demodulator 144 into types of information and outputs the result.

The sound output portion 15 outputs the sound corresponding to the television broadcast received by the receiving portion 14, and comprises a D/A converter 151, a sound signal output portion 152, and a speaker 153. The D/A converter 151 converts sound information (digital information) fed out from the TS demultiplexer 145 into an analog signal. The sound signal output portion 152 outputs the sound signal that is converted into an analog signal by the D/A converter 15 1. The speaker 153 outputs the sound corresponding to the sound signal fed out from the sound signal output portion 152.

The MPEG2 (Motion Picture Experts Group 2) decoder 16 decodes the video image information fed out from the TS demultiplexer 145 into video image information before compression.

The image output portion 17 outputs the video image information decoded by the MPEG2 decoder 16, and comprises an NTSC encoder 171, a video signal output portion 172, and a display 173. The NTSC (National Television Standards Committee) encoder 171 converts the video image information decoded by the MPEG2 decoder 16 into a television signal in NTSC format. The video signal output portion 172 outputs the television signal in NTSC format fed out from the NTSC encoder 172 to the display 173. The display 173 (monitor) comprises an LCD (Liquid Crystal Display), a PDP (Plasma Display Panel), or the like, and displays the video image corresponding to the television signal outputted from the video signal output portion 172.

The infrared communication portion 18 receives from the remote controller 2 various types of instructions including power on/off, selecting channels, and various settings of the digital broadcast receiver 1. The communication portion 19 (part of the image transmission portion), on the basis of the instructions from the MPU 11 (image transmission portion 114 as described later), transmits electronic mail to a personal computer or the like connected to the digital broadcast receiver 1 via the Internet 3.

Next, a description will be given of the operation when the digital broadcast receiver 1 receives broadcast. First, the transmitted digital broadcast waves are received by the antenna portion 141. When the operation for selecting a channel performed through the remote controller 2 is received by the digital broadcast receiver 1, the tuner 142 switches over to a transponder used for the reception. The digital broadcast waves thus received are converted into digital information by the A/D converter 143 and demodulated by the demodulator 144.

Here, the digital broadcast waves are transmitted from the transmission side (transmitting station) in the form of TS packets. The TS packets comprise video image information, sound information, control information, and the like. These types of information are separated from each another, outputted by the TS demultiplexer 145, and stored in the RAM12, respectively. Then, the sound information read out from the RAM 12 is converted into an analog signal by the D/A converter 151, and outputted as sound from the speaker 153 through the sound signal output portion 152.

In addition, the video image information read out from the RAM 12 is decoded into the video image information before compression by the MPEG2 decoder 16, converted into a television signal in NTSC format by the NTSC encoder 171, and displayed on the display 173 as a video image through the video signal output portion 172.

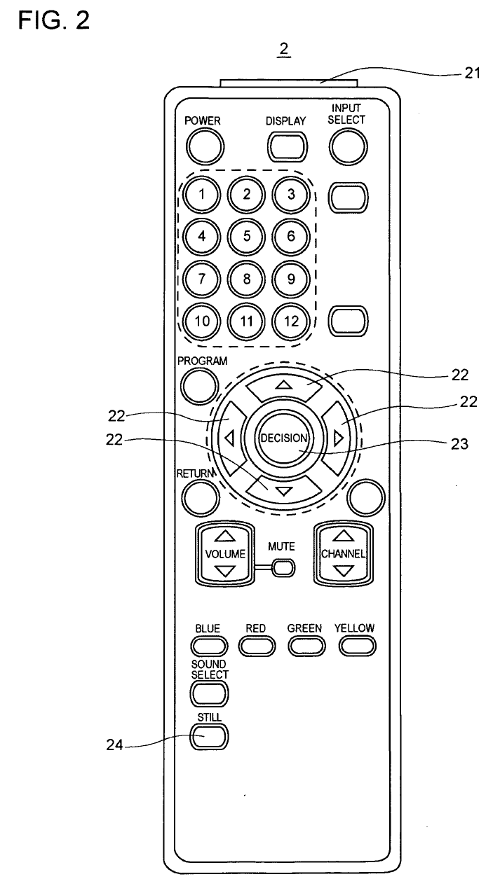

FIG. 2 is a front view showing one example of the remote controller 2. The remote controller 2 (part of the still image generating portion, part of the image transmission portion, part of the display control portion, and part of the address setting portion), by receiving input operation by the user, generates an infrared signal corresponding to the input operation and outputs the signal to the digital broadcast receiver 1, and comprises an infrared signal output portion 21, direction keys 22, a decision key 23, and a still key 24. The infrared signal output portion 21 generates an operation signal corresponding to the key pressed by the user, converts the operation signal into an infrared signal, and transmits the resultant signal to the digital broadcast receiver 1.

The direction keys 22 are the keys that are pressed down when one option is selected from among a plurality of options displayed on the display 173, and comprises an up key, a down key, a left key, and a right key. The decision key 23 is the key that is pressed down when an option that is selected by the direction keys is decided. The still key 24 (first specific key and second specific key) is the key that is pressed down when still image information corresponding to video image information is desired to be generated or when video image information received through the receiving portion 14 is desired to be displayed on the display 173 after the still image is erased by performing erasing operation while the still image is on the display 173.

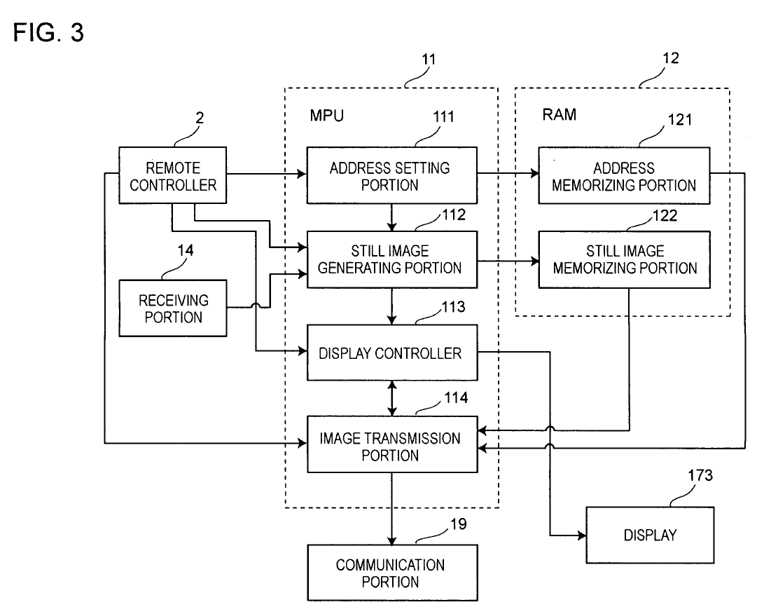

FIG. 3 is a block diagram showing one example of a configuration of the principal portion of the digital broadcast receiver 1 according to the present invention. The MPU 11 is functionally provided with an address setting portion 111, a still image generating portion 112, a display controller 113, and an image transmission portion 114. The RAM 12 is functionally provided with an address memorizing portion 121 and a still image memorizing portion 122.

Here, the MPU 11, by executing a control program stored in advance in the ROM 13 shown in FIG. 1, functions as the functional portions such as the address setting portion 111, the still image generating portion 112, the display controller 113, and the image transmission portion 114, and makes the RAM 12 function as the functional portions such as the address memorizing portion 121 and the still image memorizing portion 122.

Furthermore, among various types of data stored in the RAM 12 and the ROM 13 shown in FIG. 1, the data that can be stored in a detachable storage medium may be arranged to be readably stored by such a drive as, for example, a hard disk drive, an optical disc drive, a flexible disk drive, a silicon disk drive, or a cassette-medium reading device. In this case, the storage medium will be, for example, a hard disk, an optical disc, a flexible disk, a CD (Compact Disc), a DVD (Digital Versatile Disc), a semiconductor memory, or the like.

The address memorizing portion 121 (address memorizing portion) is for storing therein electronic mail address information that is set by the address setting portion 111. The electronic mail address information stored in the address memorizing portion 121 is read by the image transmission portion 114.

The still image memorizing portion 122 stores therein the still image information generated by the still image generating portion 112. The still image information stored in the still image memorizing portion 122 is read by the image transmission portion 114 and outputted on the display 173 through the display controller 113.

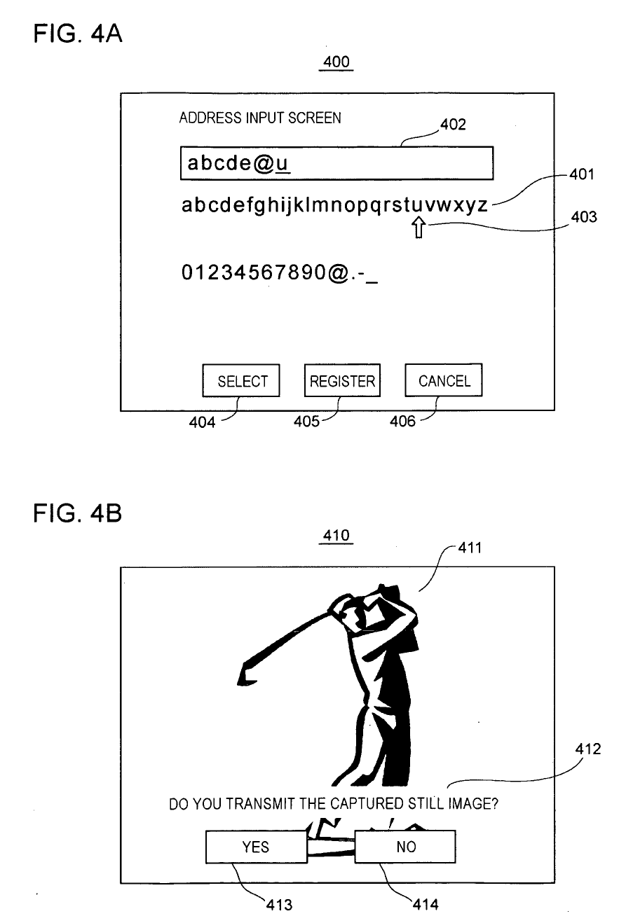

The address setting portion 111 (part of the address setting portion) receives input operation by the user through the remote controller 2, generates electronic mail address information based on the received input operation, and memorizes (writes) the result into the address memorizing portion 121. Here, the address setting portion 111 displays an address input screen 400 (refer to FIG. 4A) on the display 173 and generates the electronic mail address information through the address input screen 400.

FIG. 4A is a screen view showing one example of the address input screen 400 displayed on the display 173 by the address setting portion 111. On the address input screen 400, a character selecting portion 401 is displayed substantially in the center of the screen, and an input information display area 402 is displayed on the upper side of the character selecting portion 401. A selection mark 403 is displayed on the lower side of the character selecting portion 401. Further, a select button 404, a register button 405, and a cancel button 406 are displayed in the bottom area of the screen.

The character selecting portion 401 shows character information (alphabet, number, symbol, etc.) in a selectable manner. The selection mark 403 is a mark indicating selected character information. In this example, the selection mark 403 is shown below “u” among characters shown in the character selecting portion 401. The input information display area 402 displays entered character information sequentially.

The select button 404 is a button that is pressed when a character selected by the selection mark 403 is entered. The register button 405 is a button that is pressed when the electronic mail address information displayed in the input information display area 402 is registered (memorized in the address memorizing portion 121). The cancel button is a button that is pressed when the information displayed in the input information display area 402 is canceled. Here, “pressed” means that, taking the remote controller 2 as an example, the decision key 23 is pressed while selection has been made by the direction keys 22 provided on the remote controller 22 shown in FIG. 2.

Again, FIG. 3 is used to describe the functional arrangement of the MPU 11. The still image generating portion 112 (part of the still image generating portion) receives input operation by the user through the remote controller 2, generates still image information corresponding to the video image information received through the receiving portion 14 on the basis of the received input operation, and records (writes) the generated still image information in the still image memorizing portion 122.

To be specific, the still image generating portion 112 generates the still image information corresponding to the video image information received through the receiving portion 14 when the still key 24 (first specific key, refer to FIG. 2) provided on the remote controller 2 is pressed and accepted, and records (writes) the generated still image information in the still image memorizing portion 122. In addition, the still image generating portion 112 writes the still image information into the still image memorizing portion 122 after converting it into, for example, JPEG (Joint Photographic Experts Group) format.

Every time a still image is generated by the still image generating portion 112, the display controller 113 (part of the display control portion) makes the display 173 display thereon the generated still image.

When the still key 24 (second specific key, refer to FIG. 2) is pressed and accepted while the still image generated as described above is still displayed on the display 173 (refer to FIG. 4B), the display controller 113 erases the still image displayed on the display 173 and, thereafter, displays on the display 173 the video image information received through the receiving portion 14.

The image transmission portion 114 (part of the image transmission portion) receives input operation by the user, attaches the still image information generated by the still image generating portion 112 to the electronic mail message as an attached file based on the received input operation, and transmits the electronic mail message to which the still image information is attached to the electronic mail address stored in the address memorizing portion 121 through the communication portion 19 and the Internet 3 shown in FIG. 1.

Here, the image transmission portion 114 makes the display 173 display a transmission instruction screen 410 (refer to FIG. 4B), attaches through the transmission instruction screen 410 the still image information generated by the still image generating portion 112 to an electronic mail message as an attached file, and transmits through the communication portion 19 and the Internet 3 shown in FIG. 1 the electronic mail message to which the still image information is attached to the electronic mail address stored in the address memorizing portion 121.

FIG. 4B is a diagram of a screen showing one example of the transmission instruction screen 410 displayed on the display 173 by the image transmission portion 114. On the transmission instruction screen 410, a still image display area 411 is displayed over the entire area of the screen, and a guidance display portion 412, a Yes button 413, and a No button 414 are displayed in the bottom area of the screen.

The still image display area 411 is for displaying the still image generated by the still image generating portion 112. The guidance display portion 412 is for displaying operation guidance information. Here, a message “Do you transmit the captured still image?” is displayed and is prompting the user to perform input operation as to whether or not to transmit the still image.

The Yes button 413 is a button that is pressed when the still image is transmitted, and the No button 414 is a button that is pressed when the still image is not transmitted. When the Yes button is pressed, the image transmission portion 114 transmits the still image information displayed in the still image display area 411 to an electronic mail address stored in the address memorizing portion 121. Additionally, when the Yes button 413 or the No button 414 is pressed, the guidance display portion 412, the Yes button 413, and the No button 414 are erased and the still image display area 411 is displayed over the entire area of the screen.

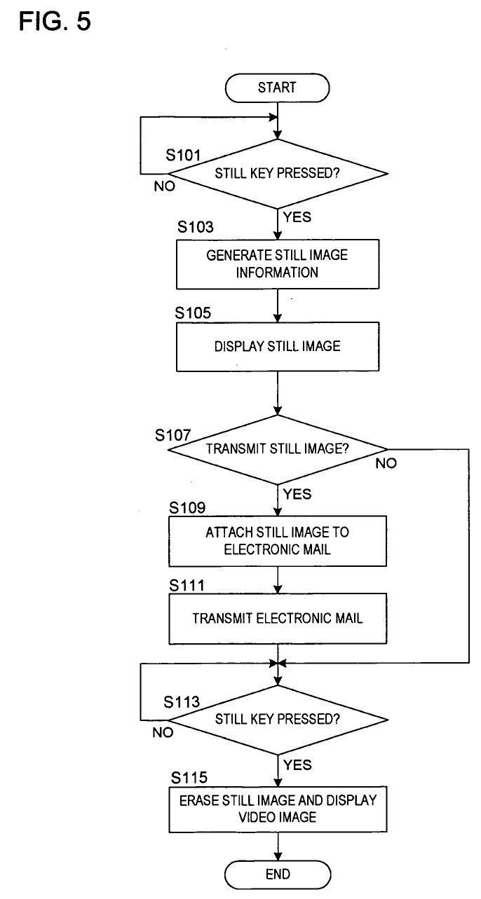

FIG. 5 is a flowchart showing one example of the operation of the digital broadcast receiver 1 (particularly MPU 11). Here, for convenience sake, a description will be given of the case in which the electronic mail address has been set in advance by the address setting portion 111 and stored in the address memorizing portion 121. First, the still image generating portion 112 determines whether or not the still key 24 is pressed and accepted (S101). When it is determined that the pressing of the still key 24 is not received (“No” in S101), the process goes into a stand-by state.

When it is determined that the still key 24 is pressed (“Yes” in S101), still image information corresponding to the video image information received through the receiving portion 14 is generated by the still image generating portion 112 and recorded in the still image memorizing portion 122 (S103). Then, the display controller 113 makes the display 173 display thereon the still image generated in step S105.

Next, the image transmission portion 114 displays the transmission instruction screen 410 shown in FIG. 4B, and it is determined whether or not the still image information generated in step S103 will be transmitted (S107). When it is determined that the still image information will not be transmitted (“No” in S107), the process goes to step S113. When it is determined that the still image information will be transmitted (“Yes” in S107), the still image information generated in step S103 is attached to an electronic mail message as an attached file by the image transmission portion 114 (S109). Then, the electronic mail message to which the still image information is attached is transmitted by the image transmission portion 114 to an electronic mail address stored in the address memorizing portion 121 (S111).

In the case of “No” in step S107 or when the process in step S111 is completed, the display controller 113 determines whether or not the still key 24 is pressed (S113). When it is determined that the still key 24 is not pressed (“No” in S113), the process goes into a stand-by state. When it is determined that the still key 24 is pressed (“Yes” in S113), the still image is erased by the display controller 113, the video image information received through the receiving portion 14 is displayed on the display 173 (S115), and the process is completed.

In this way, the electronic mail address information is stored in the address memorizing portion 121 in advance, and television broadcast of a channel set in advance is received through the receiving portion 14. Then, the input operation by the user is received through the remote controller 2. Based on the input operation thus received, still image information corresponding to the video image information received through the receiving portion 14 is generated. In addition, the input operation by the user is received through the remote controller 2. Based on the input operation thus received, the generated still image information is attached to an electronic mail message as an attached file, and the electronic mail message to which the still image information is attached is transmitted via the Internet 3 to an electronic mail address stored in the address memorizing portion 121. With this arrangement, it is possible to conveniently utilize the still image information that corresponds to the video image information.

As explained previously, the input operation by the user is received through the remote controller 2. Based on the input operation thus received, the generated still image information is attached to an electronic mail message as an attached file, and the electronic mail message to which the still image information is attached is transmitted via the Internet 3 to an electronic mail address stored in the address memorizing portion 121. Accordingly, by receiving an electronic mail message to which still image information is attached through a personal computer or the like, it is possible to utilize the still image information in various ways (for example, using a preferred still image as a wallpaper, writing down on a postcard the character information included in the still image such as a mailing address for taking part in a prize competition or the like). As a result, it is possible to conveniently utilize the still image information that corresponds to the video image information.

Conventionally, while the character information included in the still image such as a mailing address for taking part in a prize competition is written down on a post card or the like, video image information can not be watched because the still image should be displayed on the display 173 for a long period of time. However, according to this embodiment, since the electronic mail message to which the still image information is attached is transmitted via the Internet to the electronic mail address stored in the address memorizing portion 121, it is not necessary to display the still image on the display 173 for a long period of time, thereby increasing the convenience.

Furthermore, every time the still image is generated, the generated still image is displayed on display 173. Since the user can determine, by visually recognizing the still image displayed on the display 173, whether or not to transmit an electronic mail message to which the still image information is attached, it is possible to utilize further conveniently the still image information that corresponds to the video image information.

In addition, the input operation by the user is received through the remote controller 2. Based on the received input operation, electronic mail address information is generated and recorded (written) in the address memorizing portion 12. Therefore, the user can transmit an electronic mail message to which the still image information is attached to a desired electronic mail address. Thus, it is possible to utilize further conveniently the still image information that corresponds to the video image information.

When the first specific key (in this example, the still key 24, refer to FIG. 2) that is provided on the remote controller 2 and defined in advance is pressed and accepted, the still image is generated. Therefore, it is possible to utilize further conveniently the still image information that corresponds to the video image information.

Specifically, when the user wishes to transmit an electronic mail message to which still image information is attached, the still image information that can be transmitted by being attached to the electronic mail message is generated by pressing the first specific key (in this example, the still key 24, refer to FIG. 2) provided on the remote controller 2. Therefore, it is possible to utilize further conveniently the still image information that corresponds to the video image information.

When the second specific key (in this example, the still key 24, refer to FIG. 2) that is provided on the remote controller 2 and defined in advance is pressed and accepted while the still image is still displayed on the display 173, the still image that is displayed on the display 173 is erased and the video image information received through the receiving portion 14 is displayed on the display 173. Therefore, it is possible to utilize further conveniently the still image information that corresponds to the video image information.

Specifically, if the user wishes to watch the video image information when the still image is displayed on the display 173, the still image displayed on the display 173 can be erased and the video image information received through the receiving portion 14 can be displayed on the display by pressing the second specific key (in this example, the still key 24, refer to FIG. 2). Therefore, it is possible to utilize further conveniently the still image information that corresponds to the video image information.

In addition, since the first and second specific keys correspond to an identical key (in this example, the still key 24, refer to FIG. 2), it is possible to conveniently utilize the still image information that corresponds to the video image information with a simple arrangement.

It is to be noted that the present invention may also be applied to the following cases. (A) Although the case in which the broadcast receiving apparatus is the digital broadcast receiver 1 for receiving digital broadcast is described in the embodiment, the broadcast receiving apparatus may be such that receives at least one of digital broadcast and analog broadcast. For example, the broadcast receiving apparatus may be such that receives analog broadcast or that receives both digital broadcast and analog broadcast.

(B) Although the case in which the image transmission portion 114 transmits via the Internet an electronic mail message to which still image information is attached is described in the embodiment, the image transmission portion 114 may be such that transmits an electronic mail message via other networks (for example, LAN (local Area Network), WAN (Wide Area Network), or an interface such as USB (Universal Serial Bus) or the IEEE1394.

(C) Although the case in which the MPU 11 comprises the functional portions such as the address setting portion 111, the still image generating portion 112, the display controller 113, image transmission portion 114, and the like is described in the embodiment, at least one functional portion among the address setting portion 111, the still image generating portion 112, the display controller 113, and image transmission portion 114 may be realized by hardware such as a circuit or the like.

(D) Although the case in which the image transmission portion 114 transmits an electronic mail message when the Yes button 413 (refer to FIG. 4B) of the transmission instruction screen 410 is pressed is described in the embodiment, the image transmission portion 114 may transmit an electronic mail message every time the still image information is generated by the still image generating portion 112. In such a case, since the electronic mail message can be transmitted swiftly, it is possible to shorten the period in which the still image is displayed on the display 173.

(E) Although it is described in the embodiment that the display controller 113 displays on the display 173 the still image generated by the still image generating portion 112, it is also possible to make an arrangement such that whether or not the still image generated by the still image generating portion 112 is displayed on the display 173 is decided through the setting. Specifically, the input operation by the user is accepted through the remote controller 2, and there is provided a functional portion for making the setting based on the input operation thus accepted to decide whether or not the still image is displayed on the display 173.

For example, if it is set that the still image is not displayed on the display 173, it may be configured in such a way that the image transmission portion 114 transmits an electronic mail message every time the still image is generated by the still image generating portion 112. In this case, it is possible to eliminate a time required for displaying the still image on the display 173.

What is claimed is:

1. A broadcast receiving apparatus that is arranged to be capable of transmitting electronic mail via a network, receives television broadcast, and is connected to a monitor in such a manner as to display received video image information on the monitor, comprising:
address memorizing portion for storing electronic mail address information in advance;
receiving portion for receiving television broadcast of a preset channel;
still image generating portion that receives input operation performed externally, and that, based on the input operation thus received, generates still image information corresponding to video image information received through the receiving portion; and
image transmitting portion that receives input operation performed externally, and that, based on the input operation thus received, attaches the still image information generated by the still image generating portion to an electronic mail message as an attached file and transmits the electronic mail message to which the still image information is attached to an electronic mail address indicated by the electronic mail address information stored in the address memorizing portion.

2. The broadcast receiving apparatus according to claim 1,
wherein the broadcast receiving apparatus further comprises display control portion that, every time still image information is generated by the still image generating portion, displays the still image information thus generated on the monitor.

3. The broadcast receiving apparatus according to claim 2,
wherein the broadcast receiving apparatus further comprises address setting portion that receives input operation performed externally, that, based on the input operation thus received, generates electronic mail address information, and that records the electronic mail address thus generated in the address memorizing portion.

4. The broadcast receiving apparatus according to claim 2,
wherein the broadcast receiving apparatus is connected, in a communicable manner, to a remote controller provided with a plurality of keys, and
the still image generating portion, upon receiving a signal indicating that a first specific key defined in advance and provided on the remote controller is pressed, generates the still image information.

5. The broadcast receiving apparatus according to claim 4,
wherein the display control portion, upon receiving a signal indicating that a second specific key defined in advance and provided on the remote controller is pressed while the still image information is displayed on the monitor, erases the still image information displayed on the monitor and displays on the monitor the video image information received through the receiving portion.

6. The broadcast receiving apparatus according to claim 5,
wherein the first specific key and the second specific key correspond to an identical key provided on the remote controller.
